(19) United States
(12) Patent Application Publication
(10) Pub. No.: US 2014/0149861 A1
(43) Pub. Date: May 29, 2014

(54) METHOD OF DISPLAYING MUSIC LYRICS AND DEVICE USING THE SAME

(71) Applicant: HTC Corporation, Taoyuan County (TW)

(72) Inventors: I-Fen Shih, Taoyuan County (TW); Chia-Yao Lin, Taoyuan County (TW)

(73) Assignee: HTC Corporation, Taoyuan County (TW)

(21) Appl. No.: 14/083,457

(22) Filed: Nov. 19, 2013

Related U.S. Application Data
(60) Provisional application No. 61/729,416, filed on Nov. 23, 2012.

(51) Int. Cl. G06F 3/0488

(52) U.S. Cl. CPC G06F 3/0488
USPC 715/716

(57) ABSTRACT

The present disclosure the proposes a method of displaying and seeking lyrics and an portable handheld electronic device using the same. The method includes the steps of selecting an audio recording and displaying a progress indicator of the audio recording. After receiving a touch signal on the progress indicator, the device would locate the segment of lyrics of the audio recording which is based on the location of the signal on the progress indicator. Next a pop up window on the touch screen would emerge from the progress indicator and be displayed, and the lyrics would be displayed within the frame of the pop up window. The lyrics could be one line or two lines only. The audio recording and/or the lyrics could be played from the beginning of the line corresponding to the location of the touch signal on the progress indicator.

### CROSS REFERENCE TO RELATED APPLICATION

This application claims the priority benefit of U.S. provisional application Ser. No. 61/729,416, filed on Nov. 23, 2012. The entirety of the above-mentioned patent application is hereby incorporated by reference herein and made a part of specification.

### BACKGROUND

1. Technical Field

The present disclosure generally relates to a method of displaying music lyrics on a portable handheld electronic device, a device using the same method, and an user interface using the same method. In particular, the method, device, and user interface described herein generally relate to a music application of a portable handheld electronic device such as a smart phone.

2. Related Art

A multi-purpose mobile communication device such as a smart phone has been a preeminent derivative of the most recent technological development as data processing, personal organizing, multimedia applications with touch screens, and telephone functions are integrated into a portable pocket sized computer. As communication devices have become increasingly versatile, recent smart phones have included the music feature which enables users to import or to download music into the communication device in order to be enjoyed. In particular, a user may access the music feature of a smart phone by operating one's home screen and then selecting a music application icon which typically would provide a user interface to access each audio recordings. A user may download music from a server or may import music by synchronizing with one's personal computer through a parallel port.

Although a communication device often includes music features which enable a user to obtain music and to play audio recordings. At the present time, a user may somewhat emulate a Karaoke like feature by looking up lyrics of a audio recording and then singing along as a tune is being played; however, a feature to display music lyrics corresponding to the melody being played in a portable handheld electronic device has not yet been common.

FIG. 1 illustrates a user interface 100 of a typical music playing application currently in one's smart phone. In the user interface, there could be a system information panel 101, a main display area 102, and a control interface 103. The system information panel may display system information such as battery capacity, time, wireless network information, wireless signal strength, and so forth. The main display area 102 may display a variety of information related to a audio recording being played. The control interface 103 through a touch screen would receive user input and provide appropriate control functions. The control interface 103 may include a audio recording progress indicator 104 which indicates the progress of a audio recording currently being played. Since smart phones possess touch screen features, a user may alter the location or progress of a audio recording by a tap gesture or a touch and drag gesture.

For the scenario of FIG. 1, if a user taps the first location 105a on the progress indicator 104, the progress of the audio recording would be changed to time 0:31 which indicates 31 seconds from the beginning of an audio recording. Four minutes and 5 seconds (4:05) is the total time of the audio recording. After the first location 105a has been touched, the user may change the process of the audio recording to another time either by taping another location (e.g. the second location 105b) on the progress indicator or by performing a touch and drag operation from the first location 105a to the second location 105b on the progress indicator.

If a lyric displaying capability is to be implemented on a smart phone such as to enable a sing along or a Karaoke like feature, the implementation would not be without difficulties as a portable device usually has certain physical constraints—a portable handheld device is typically required to take on attributes of lightness, slimness, shortness and smallness. These physical constraints would mean that the size of a touch screen disposed on a portable device is constricted, and the number of keys and buttons disposed on a portable device thereon and sizes are also limited. Reduction of the screen size may limit batches of information capable of being displayed on the screen, and reduction of the number of the keys and the size thereof increases difficulty of user input as a user may struggle to spend considerable time and effort to navigate around an audio recording to seek lyrics through a user interface. Furthermore, the most recent smart phones are required to be aesthetically pleasing which may further complicate the functional design of a smart phone.

One possible solution to implement lyrics display is shown in FIG. 2. The solution could be to display lines of lyrics in the background section 102 and then implement a mean to correlate between the melody currently being played and the its corresponding lyrics. It should be noted that the concept of FIG. 2 should not be construed as an admission of knowledge in the prior art. One challenge related to the implementation of FIG. 2 is that because of the size limitations of a portable handheld device, a user may not want to display all the lyrics on a small screen as the user might have difficulties deciphering each word. Also, if a song lyrics is long, a user may need to scroll in order to find a particular line of lyrics, and scrolling not only adds to the complexity of the interface but diminish the aesthetic value of the design.

Furthermore, when a user seeks a particular section of an audio recording to sing along, the user normally would want to sing from the beginning of a line and also display lyrics from the beginning of a line. Currently, there has been no easy way for a user to navigate a control interface to locate the beginning of a line. For the scenario of FIG. 2, assuming that a user wants to sing from the beginning of line 3 which corresponds to time 0:31 on a progress indicator 104. In order to locate the beginning of line 3, the user would need to navigate along the progress indicator 104 in order to find the precise location from the beginning of line 3. Such maneuver could be tedious and time consuming on a small touch screen since normally when a user presses on the progress indicator, chances are the music would not be played right at the beginning of a line so that the user would need to drag around the progress indicator in order to find the exact spot.

Therefore, at the present time, there needs to be a method and a device to provide a music lyrics displaying and seeking function for use by a portable handheld communication device with a touch screen such that a user can be more fully immersed in a sing along experience using one's device.

### SUMMARY OF THE DISCLOSURE

Accordingly, the present disclosure proposes a method of displaying music lyrics via a user interface on a portable handheld electronic device and a portable handheld electronic device using the same such that a user may be more fully immersed in one's Karaoke like experience and to be able to locate music and lyrics easily in a line by line basis.

In one of the exemplary embodiments, the proposed method includes the steps of selecting and an audio recording from a touch screen, and display a progress indicator of the audio recording. After receiving a touch signal on the progress indicator, the device would locate the segment of lyrics of the audio recording which is based on the location of the signal on the progress indicator. Next a window on the touch screen would be displayed and would emerge from the touch signal on the progress indicator, and the lyrics would be displayed within the frame of the first window.

In one of the exemplary embodiments, the segment of lyrics could be a line of lyrics as typically recorded in a score sheet or could be a line of lyrics as typically recorded in a music video such as a music video of the song played in KTV.

In one of the exemplary embodiments, the lyrics would only be one line or two lines.

In one of the exemplary embodiments, the lyrics would be displayed without the frame of the first window.

In one of the exemplary embodiments, wherein the step of locating the line of lyrics of the audio recording which is based on the location of the signal on the progress indicator would include identifying the time stamp of the beginning of that particular line of lyrics of the audio recording and then the audio recording would be interrupted and played from the time stamp of the beginning of the line of lyrics.

In one of the exemplary embodiments, first of all, all the lyrics of an audio recording would be divided into a plurality of segments based on a predetermined pattern, and each word of the lyrics would be associated with a time stamp of the audio recording. After lyrics are segmented, when a touch signal on the progress indicator is detected, the corresponding segment would be located from the plurality of segments. These steps could be accomplished before the audio recording is activated. The purpose of these steps is to play a line of an audio recording and its corresponding lyrics from the beginning of a line rather than somewhere in the middle of a line.

In one of the exemplary embodiments, right after the first touch signal is received, the first window disappears after a predetermined period if no further signal is received on the progress indicator.

In one of the exemplary embodiments, when a second touch signal on the progress indicator is received, the device would seek the corresponding line of lyrics of the audio recording based on the location of the second touch signal on the progress indicator. The device would then display a second window on the touch screen and display the corresponding line of lyrics on the second window or displaying the corresponding line of lyrics and the next line of the audio recording within the second window.

In one of the exemplary embodiments, first window and the second window would over write the background of the display. The second window would over write the first window if the second window is more recent of the two windows.

In one of the exemplary embodiments, the first window would be deactivated and cease to exist when the second window is activated.

In one of the exemplary embodiments, the first window is displayed such that the first window is connected to and corresponds to the location of the first touch signal on the progress indicator.

In one of the exemplary embodiments, after receiving a third touch and drag signal which drags along on the progress indicator starting from the location of first touch signal to the location where the third touch and drag signal ends on the progress indicator, the device seeks the corresponding line of lyrics of the audio recording based on the location of the end of the third touch and drag signal. The first window on the touch screen would be relocated to where the third touch and drag signal ends on the progress indicator.

In one of the exemplary embodiments, only one line of lyrics would be displayed except for the situation when the line of lyrics exceeds the width of the window. In this case, the very next line would also be displayed.

In one of the exemplary embodiments, the present disclosure directs to a portable handheld electronic device which includes at least the elements of a storage medium configured for storing at least an audio recording, an input unit configured for receiving a first touch signal, a touch screen coupled to the input unit and configured for displaying an album art, a progress indicator, and a first window, and a processor coupled to the storage medium, the input unit, and the touch screen, and the processor is configured to execute the functions of selecting the audio recording, simultaneously playing the audio recording and displaying the album art and displaying the progress indicator of the audio recording, receiving the first touch signal on the progress indicator, seeking the line of lyrics of the audio recording based on the corresponding location of the first touch signal on the progress indicator, displaying the first window on the touch screen as the first window emerges from the touch signal on the progress indicator, and displaying the line of lyrics or displaying one or two lines of lyrics of the audio recording within the first window on the touch screen.

In one of the exemplary embodiments, when the processor seeks the line of lyrics of the audio recording based on the corresponding location of the first touch signal on the progress indicator, the processor is configured to execute identifying the time stamp of the beginning of the line of lyrics of the audio recording and changing the playing of the audio recording by playing the audio recording starting from the time stamp of the beginning of the line of lyrics.

In one of the exemplary embodiments, before the processor identifies the time stamp of the beginning of the line of lyrics of the audio recording, the processor is configured to execute dividing all lyrics of the audio recording into a plurality of segments based on a predetermined pattern and associating each word of the lyrics with a time stamp from the audio recording, identifying from the plurality of segments a corresponding segment from which the first touch signal is located on the progress indicator, and identifying the corresponding segment as the line of lyrics.

In one of the exemplary embodiments, right after the first touch signal is received by the input unit, the touch screen no longer displays the first window after a first predetermined period if the input unit does not detect any more signal on the progress indicator.

In one of the exemplary embodiments, when the input unit receives a second touch signal on the progress indicator, the processor is configured to execute the function of seeking the line lyrics of the audio recording based on the corresponding location of the second touch signal on the progress indicator, displaying a second window on the touch screen when seeking lyrics of the audio recording, and displaying the line of lyrics on the second window or displaying the line of lyrics and the next line of the line of lyrics of the audio recording within the second window on the touch screen.

In one of the exemplary embodiments, the touch screen would display a second window which over writes the first window, if the second window is more recent, and both the first window and the second window over write the background display of the touch screen.

In one of the exemplary embodiments, the first window would be deactivated and cease to exist on the touch screen when the second window is activated.

In one of the exemplary embodiments, the first window displayed by the touch screen would further displays the first window being connected to and corresponds to the location of the first touch signal on the progress indicator as detected by the input unit.

In one of the exemplary embodiments, the processor is further configured to execute the function of receiving through the input unit a third touch and drag signal on the progress indicator from the location of the first touch signal to where the third touch and drag signal ends on the progress indicator, seeking the line of lyrics of the audio recording based on the corresponding location of the end of the third touch and drag signal, and moving the first window on the touch screen when seeking the line of lyrics of the audio recording to a location corresponds to the location where the third touch and drag signal ends on the progress indicator.

In one of the exemplary embodiments, the processor is configured such that only one line of lyrics would be displayed in the touch screen except for the situation when the line of lyrics exceeds the width of the window. In this case, the very next line would also be displayed.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a user interface or a conventional music player.

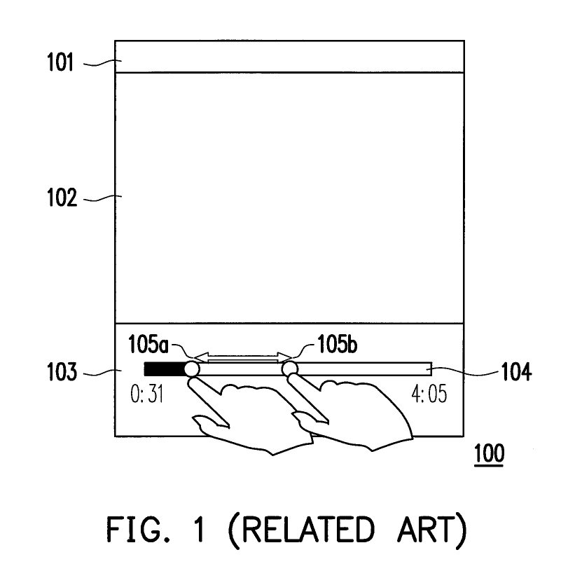

FIG. 2 illustrates displaying lyrics on a user interface.

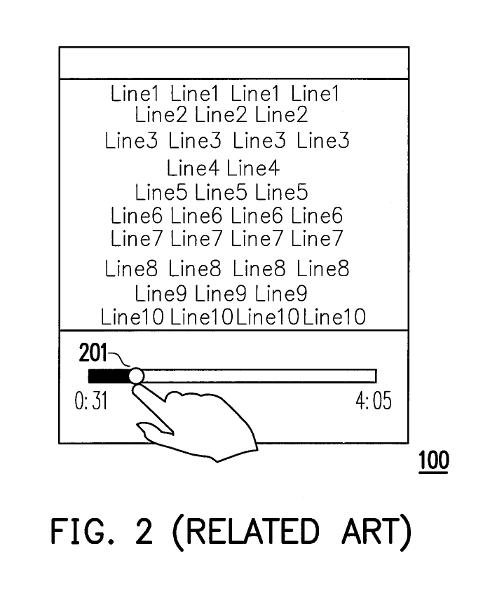

FIG. 3 illustrates a hardware diagram of an exemplary handheld mobile electronic device.

FIG. 4 illustrates a music interface for displaying lyrics in a pop up window in accordance with one of the exemplary embodiments of the present disclosure.

FIG. 5 illustrates a music interface for displaying lyrics in a second pop up window in accordance with one of the exemplary embodiments of the present disclosure.

FIG. 6 is a flow chart which illustrates a method of displaying lyrics in a pop up window in accordance with another one the exemplary embodiments of the present disclosure.

FIG. 7 is a flow chart which illustrates a method of seeking lyrics to be displayed in a pop up window in accordance with another one the exemplary embodiments of the present disclosure.

### DETAILED DESCRIPTION OF DISCLOSED EMBODIMENTS

No element, act, or instruction used in the description of the present application should be construed as absolutely critical or essential to the present disclosure unless explicitly described as such. Also, as used herein, each of the indefinite articles “a” and “an” is intended to exclude more than one item. If only one item is intended, the terms “a single” or similar languages could be used. Furthermore, the terms “any of followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

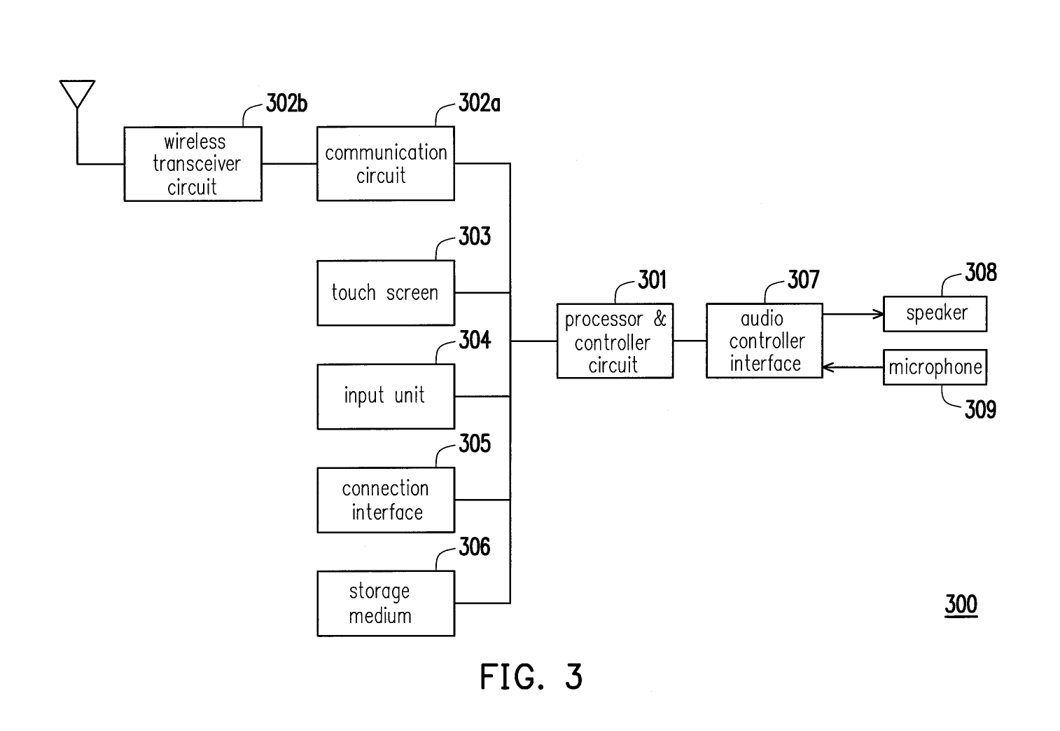

FIG. 3 illustrates a hardware diagram of an exemplary portable handheld mobile electronic device 300 for implementing the method of the present disclosure. The electronic device 300 would be easily portable and could be held by a person hand. Examples of the above mentioned device could be a smart phone, a mobile phone, a walkie talkie, a radio, a disc player, a boom box, a person digital assistant (PDA), an electronic personal organizer, a notebook computer, and so forth.

The exemplary electronic device 300 would include a processor and controller circuit 301. The processor and controller circuit 301 would be electrically coupled to at least but not limited to a communication 302a, a touch screen 303, an input unit 304, a connection interface 305, a storage medium 306, and an audio controller interface 307. The processor and controller circuit 301 may include a micro-controller, a North Bridge, a South Bridge, a field programmable array (FPGA), a programmable logic device (PLD), an application specific integrated circuit (ASIC), or other similar device, or a combination therefore. The processor and controller circuit 301 may also include a central processing unit (CPU) or a programmable general purpose or special purpose microprocessor, a digital signal processor (DSP), a graphics processing unit (GPU), an application specific integrated circuit (ASIC), a programmable logic device (PLD), or other similar device or a combination thereof, which is used for processing all tasks of the exemplary electronic device 300.

The communication circuit 302a could be components which support signal transmissions of a global system for mobile communication (GSM), a personal handy-phone system (PHS), a code division multiple access (CDMA) system, a wireless fidelity (Wi-Fi) system or a worldwide interoperability for microwave access (WiMAX). The communication circuit 302a may also include a wireless transceiver unit 302b to provide wireless access for the portable handheld device. The transceiver unit 302b may include but not limited to a transmitter circuit, a receiver circuit, an analog-to-digital (A/D) converter, a digital-to-analog (D/A) converter, a low noise amplifier (LNA), mixers, filters, matching networks, transmission lines, a power amplifier (PA), one or more antenna units, and a local a storage medium. The transmitter and the receiver transmit downlink signals and receive uplink signals wirelessly. The receiver may include functional elements to perform operations such as low noise amplifying, impedance matching, frequency mixing, down frequency conversion, filtering, amplifying, and so forth. The transmitter may include function elements to perform operations such as amplifying, impedance matching, frequency mixing, up frequency conversion, filtering, power amplifying, and so forth. The analog-to-digital (A/D) or the digital-to-analog (D/A) converter is configured to convert from an analog signal format to a digital signal format during uplink signal processing and from a digital signal format to an analog signal format during downlink signal processing.

The touch screen 303 may contain a display such as a liquid crystal display (LCD), a light-emitting diode (LED) display, a field emission display (FED) or other types of display. The input unit 304 could be, for example, an input device such as a mouse, a keyboard, a joystick, a wheel, and so forth and would receive an input operation from a user. The input unit 304 may also include a resistive, a capacitive or other types of touch sensing device which would be integrated as a part of the touch screen 303.

The connection interface 305 could be, for example, a cable interface such as a universal serial bus (USB) or a wireless interface such as Bluetooth. The connection interface 305 could be a serial interface such as RS232 interface or could be a parallel interface such as USB or Firewire.

The storage medium 306 could volatile or permanent memories which would store buffered or permanent data such as compiled programming codes used to execute functions of the exemplary electronic device 300.

The audio controller interface 307 may include an audio code and electrical to acoustic signal transducer. The audio controller interface 307 and may receive acoustic to electrical signals from a microphone 309 and transmit electrical to acoustic signals to a speaker 308.

At the present time, a user may somewhat emulate a Karaoke like feature by looking up lyrics of a audio recording and then singing along as a tune is being played; however, a feature to display music lyrics corresponding to the melody currently being played in a portable handheld electronic device has not yet been common. To implement a features, physical constraints such as smaller screen sizes would pose a challenge to implement such feature. Also when a user seeks a particular section of an audio recording to sing along, the user normally would want to sing from the beginning of a line and also to display lyrics from the beginning of a line. Therefore, there needs to be a method and a device to locate and to display lyrics on a line by line basis.

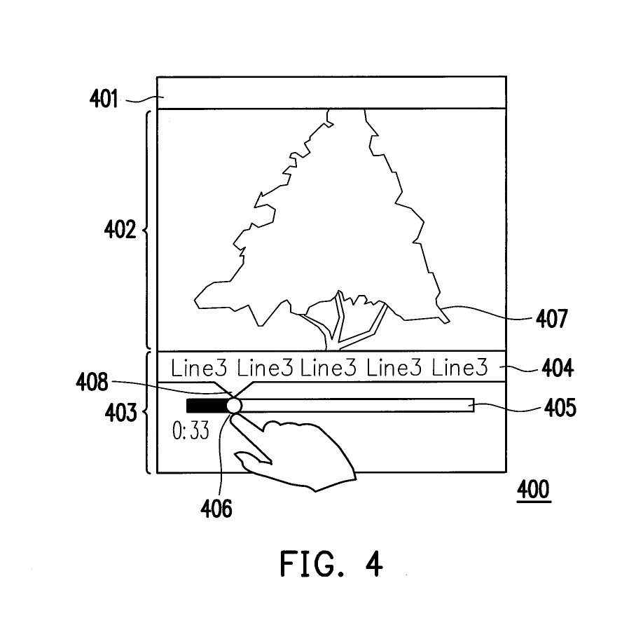

The exemplary electronic device 300 displays a user interface which may include a home screen. From the home screen, a user may access a music application and play music through the music application. The music application may include an application specific user interface. FIG. 4 illustrates a music interface for displaying lyrics in a pop up window on a touch screen in accordance with one of the exemplary embodiments of the present disclosure. The music interface 400 on a touch screen 303 as illustrated in FIG. 4 could include a first display area 401, a second display area 402, a third display area 403. The first display area 401 may display system information which may include battery capacity, time of the day, wireless connection information, wireless signal strength, and so forth. The second display area 402 may display customized background information or song specific art such as an album art 407 which could be obtained from one's laptop or PC through the connection interface 305 through a synchronization process or could be user customized. The album art 407 could also be obtained from an external server through the communication circuit 302a. The album art 407 could be a still picture, a looped motion picture, a video, or a movie. The third display area 403 mostly is related to providing a control related interface such as selecting a song, selecting an album, and altering the location of the song being played. In accordance with the present disclosure, the third display area 403 may display a song progress indicator 405 through which a user may skip to any second of a song. For example, suppose that a song is 6 minutes and 33 seconds long, the starting point in the progress indicator 405 would be 0 minute and 0 second, and the end would be 6 minutes and 33 seconds. After a song has been played, the song could be skipped to the 33^{rd} second (0:33) and start playing at that point when the input unit 304 detects a touch signal on the location of the progress indicator 405 corresponding to the 0 minutes and 33^{rd} second location.

According to one of the exemplary embodiments, the lyrics displaying function is implemented as follows. First, assuming that an audio recording has been selected and activated (not shown) through the music interface 400, the second display area 402 would display an album art, and the third display area 403 would display an progress indicator 405 as the audio recording is being played. In response to the progress indicator 405 detecting a first touch signal by the input unit 304 on the progress indicator 405, the audio recording would be skipped to the location of the first touch signal 406 on the progress indicator 405. A first window 404 which could be similar to a pop up window would then appear in response to the first touch signal 406. The window frame 404 would display either one line of lyrics or two lines of lyrics only. Since the screen of portable handheld device is limited in size, a user may not want to read more than just one or two lines of lyrics. Also by using the second display area 402 to display an album art 407, it may not only enhances the aesthetics of the overall display but also assist a user to be more fully immersed in one's singing experience. Furthermore, suppose in the case that the second display area 402 also displays lines of lyrics rather than a background art, the lines of lyrics in the second display area 402 may actually become a visual distraction and hinder the user's endeavor to read the lyrics within the window frame 404. Therefore, for the present embodiment, only one or two lines of lyrics would be displayed and also the lyrics would only be displayed within pop up window.

According to one of the exemplary embodiment, the pop up window 404 may appear in the third display area 403 or the second display area 402 in a way such that the entire window 404 may overwrite the third display area 403 in part or the second display area 402 in part when the input unit 304 detects a touch signal on the progress indicator 405. The pop up window 404 could be displayed such that the window 404 includes a bridge 408 so that the window frame is connected to the location of the touch signal through the bridge 408 in order to indicate where on the progress indicator 405 the touch signal has been detected by the input unit 304. In other words, when a user presses a first location 406 on the progress indicator 405, the audio recording would be skipped to the first location 406 and a lyrics pop up window 404 would appear to display one or two lines of lyrics corresponding to the audio recording at the time of the pressed first location 406 on the progress indicator 405. If a user had pressed a second location (not shown) on the progress indicator 405, the lyrics pop up window 404 may appear such that the bridge 408 of the pop up window points to the second location to display one or two lines of lyrics corresponding to the audio recording at the time of the second location of the progress indicator 405. However, in one of the exemplary embodiment, the bridge 408 may not exist.

In another exemplary embodiment, when a user presses a first location 406 on the progress indicator 405, the audio recording would be skipped to the first location 406 and a lyrics pop up window 404 would appear to display not the current one or two lines of lyrics but the next one or two lines of lyrics corresponding to the audio recording at the time of the pressed first location 406 on the progress indicator 405.

According to one of the exemplary embodiments, right after the input unit 304 detects a touch signal on the progress indicator 405 and subsequently causes a pop up lyrics window 404 to be displayed, the touch screen 303 would stop displaying the pop up lyrics window 404 after a predetermined period if no further signal is received on the progress indicator 405. The predetermined period could be 15-20 seconds. According to another one of the exemplary embodiment, a user can turn off the pop up window by pressing a button through the touch screen.

According to another one of the exemplary embodiments, only one line of lyrics would be displayed rather than two. The advantage of such is to minimize the clutter on the screen or to maximize the words being displayed.

According to another one of the exemplary embodiments, only one line of the lyrics would be displayed except for the situation when the line of lyrics exceeds the width of the window frame. In this case, the very next line would also be displayed. Also in all the embodiments, whenever a second line of lyrics is displayed in the window frame, the second line of lyrics would be the immediate next line of lyrics from the previous line.

According to one of the exemplary embodiments, the displaying of lyrics by the touch screen 303 could be implemented as follows. First, an audio recording would contain information related to time stamps, and each line of the lyrics of the audio recording would be associated with a certain time stamp so that when the audio recording is being played in any particular point in time, the corresponding lyrics may be highlighted. Also in another exemplary embodiment, each word of the lyrics of the audio recording could be associated with a certain time stamp, and by synchronizing each word with a time stamp, the displaying of the lyrics could be more precise. Essentially, the electronic device 300 would attempt to display an entire line of lyrics from the beginning. In other words, if a user skips the currently played audio recording to a particular point in time, the entire line of the corresponding lyrics from the beginning of the line would be displayed in the window frame 404. It should be noted that lines of lyrics maybe pre-segmented into portions based on a predetermined pattern. For example, the lyrics could be pre-segmented according to how lines are determined by the sheet music of a song, or the lyrics could be pre-segmented based on complete sentences. Pre-segmentation means that the lyrics of an audio recording may already be divided into segments when it is obtained from a server or from another external source such as a laptop or PC. The purpose is to implementation the feature of playing lyrics from the beginning of a line rather than from somewhere in the middle of a line in response to a user's input on a progress indicator whenever a user chooses to activate this feature.

According to one of the exemplary embodiments, the lyrics would be displayed from the beginning of a line even through an audio recording may be skipped to somewhere in the middle of a line. According to another one of the exemplary embodiment, the lyrics would be displayed from the beginning of a line, and an audio recording would also be skipped to the beginning of a line as well. This could be accomplishes based on locating the corresponding line of lyrics of the audio recording when a touch signal is detected on a progress indicator 405. From this particular line of lyrics, the beginning of this line could be located, and the time stamp right before the beginning of this line of lyrics could then be located. The audio recording could then be skipped from the time stamp right before the beginning of the line of lyrics rather than from the location of the touch signal on the progress indicator 105.

Referring to FIG. 4 as an example. When a first touch signal 406 is detected at time 0:33 on the progress indicator, it would then be determined that time 0:33 corresponds to the third line of lyrics, and the touch screen 303 would then display the third line starting from the beginning. Since for one of the exemplary embodiments the audio recording would be skipped to the beginning of the third line of lyrics rather than at time 0:33, the audio recording would most likely be skipped to the time before 0:33 based on whichever time stamp is right before the third line of lyrics. However, for one of the exemplary embodiments, the audio recording would be skipped to exactly at time 0:33 but the lyrics would be displayed in the window 404 from the beginning of a line.

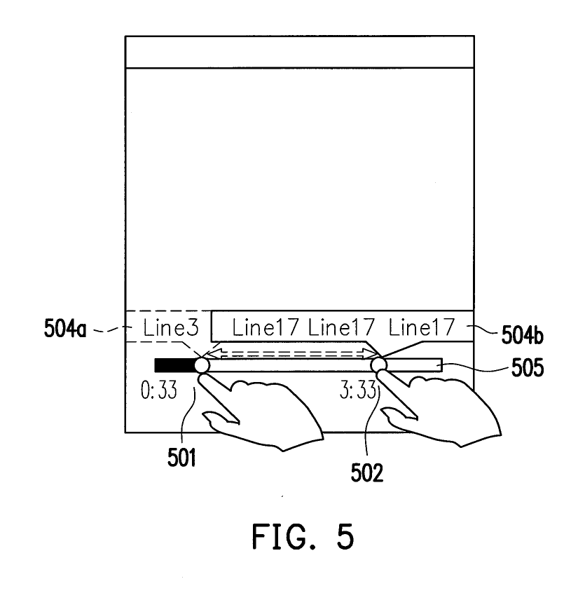

FIG. 5 illustrates a music interface for displaying lyrics in a second pop up window in accordance with one of the exemplary embodiments of the present disclosure. Assuming that a first pop up window 504a is currently displaying lyrics line 3 on the touch screen 303, and the first pop up window 504a corresponds to the first touch signal 501 at time 0:33 of the progress indicator 505, a second pop up lyrics window 504b would also be activated and appear in the second display area 402 or third display area 403 when the touch screen 304 detects on the progress indicator 505 a second touch signal 502 which corresponds to time 3:33 on the progress indicator 505. The second window 504b would then display lyrics corresponding to time 3:33 and is line 17 in this example. Just like the first pop up lyrics window 504a, the second lyrics window 504b would also display either one or two lines of lyrics. The second lyrics window 504b could also be deactivated and disappear from the touch screen 303 due to inactivity over a predetermined period, such as between 15 to 20 seconds.

Also according to one of the exemplary embodiments, the second window 504b would over write and cover up the first window 504a partially or completely if the second window 504b is displayed on the touch screen 303 after the first window 504a. According to one of the exemplary embodiment, the first window 504a would be deactivated and disappear after the second window 504b is activated and displayed. According to one of the exemplary embodiments, the first window 504a and the second window 504b would both over write the contents displayed by the second display area 302 or the third display area 303, and one of the first window 504a and the second window 504b would over write the other depending on which one is more recent of the two.

In one of the exemplary embodiments, assuming that after the first touch signal 501 has been received by the input unit 304, a subsequent drag signal has been detected to move the first touch signal 501 to another location which is at time 3:33 of the progress indicator 505, the first pop up window 504a would then move to correspondingly to another location and display the line of lyrics from the beginning of the line corresponding to time 3:33 which in this example is line 17 of the audio recording. In general, when a touch and drag signal has been detected on a progress indicator, the audio recording would be skipped along the progress indicator as well as their corresponding lyrics displayed in a pop up lyrics window, but the lyrics would be displayed from the beginning.

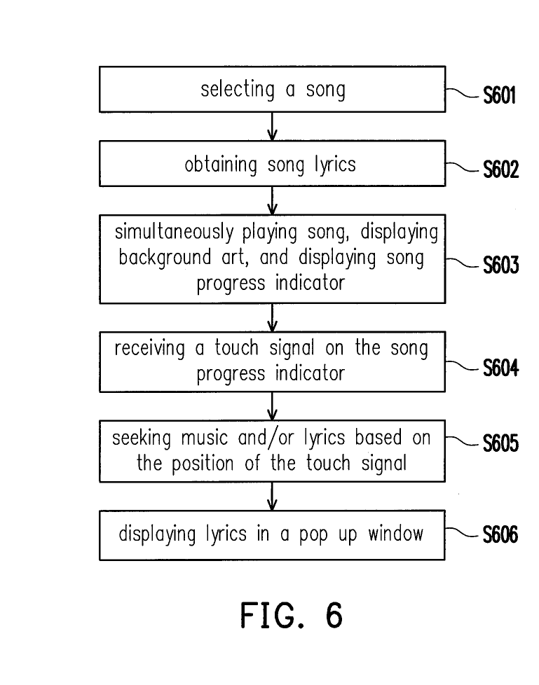

FIG. 6 is a flow chart which illustrates a method of displaying lyrics in a pop up window for use by a portable handheld electronic device in accordance with another one the exemplary embodiments of the present disclosure. In step S601, a user selects an audio recording through a music interface on a touch screen, and then the song is loaded from a storage medium. The music interface could be from an independent application, a widget, an inherent part of the operating system. In step S602, the lyrics of the audio recording would also be loaded from a storage medium or obtained externally from an external server via a communication circuit or from synchronization with another electronic device. In step S603, the portable handheld electronic device would simultaneously play the audio recording, display an album art, and display a progress indicator to indicate the progress of the audio recording in terms of time. It should be noted that order of steps S601, S602, and S603 is merely exemplary as these steps could be executed in any order.

In step S604, an input sensor unit through a touch screen detects an input signal on the progress indicator. In step S605, the portable handheld electronic device skips the audio recording to the time of the input signal on the progress indicator and seeks the lyrics which corresponds to the time of the input signal on the progress indicator. It should be noted that a song could be skipped forward or backward. In step S606, the touch screen displays a pop up window which displays the sought lyrics in format of either one or two lines on the touch screen. The pop up window could either be connected to the progress indicator to indicate the time stamp of the touch signal or the pop window could include a pointer to achieve the same function by pointing to the time stamp of the touch signal on the progress indicator. The pop window could also be configured to be disabled after a predetermined period.

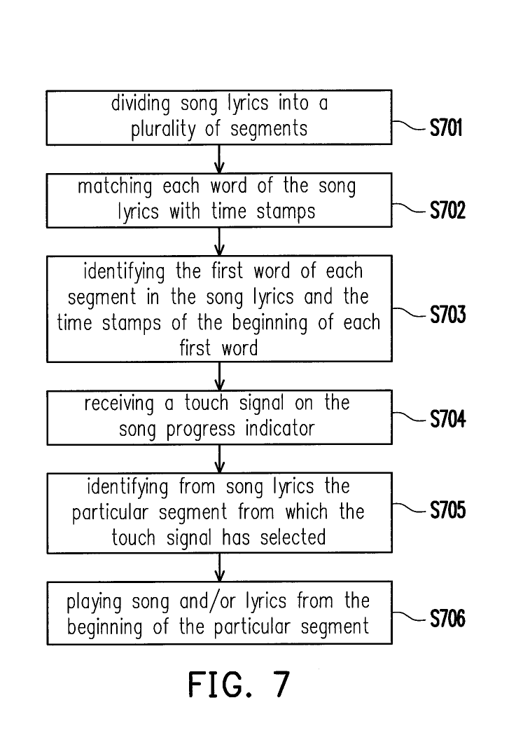

FIG. 7 is a flow chart which illustrates a method of seeking lyrics to be displayed in a pop up window or use by a portable handheld electronic device in accordance with another one the exemplary embodiments of the present disclosure. In step S701, before or after an audio recording would have been selected in step S601, the lyrics of audio recording would be divided into a plurality segments or lines. In step S702, each word of the lyrics of the audio recording would be associated with a time stamp such that when a song reaches a particular time stamp, each word of the lyrics could be highlighted. In step S703, the first word of each segment of the lyrics of the audio recording would be identified. The identification may also include identifying the time stamp right before the first word of each segment of the lyrics. In step S704, a touch signal is received on a progress indicator which has been displayed on a touch screen. In step S705, the particular segment of lyrics which corresponds to the location of the touch signal on the progress indicator is identified. In step S706, the particular segment of lyrics would be displayed on a pop up window from the beginning of the segment, and also the music may also be skipped to right before the beginning of the segment according to the time stamp right before the beginning of the first word of the segment.

It should be noted that in all the embodiments, whenever a song is mentioned, the same concept may also apply to any audio recording in general. For instance, a user may want to listen to a speech or a lecture without any melody. In this case, the audio recording may be segmented according to a sentence by sentence basis, and a user may skip an audio record forward or backward automatically to right before the beginning of a sentence.

In view of the aforementioned descriptions, the present disclosure is able to play an audio recording while at the same time displaying lyrics on a portable handheld electronic device such that a user may enjoy a Karaoke like sing along experience using one's portable handheld electronic device. A user may use an interface to seek the lyrics which would be displayed in either one or two lines so as to improve the readability of the lyrics. Because of the limitation of the screen size of a portable handheld electronic device, the present disclosure proposes that only one or two lines of lyrics is displayed. Also in order to enhance the singing experience from the aesthetic and user immersion stand point, the present disclosure proposes displaying lyrics in a pop up window which may overwrite an album art in the background but could be turned off whenever a user chooses to. Also by automatically skipped the audio recording to the beginning of a line as well as displaying lyrics to the beginning of the line, the sing along experienced would be enhanced as the user would be able to seek lyrics in a line by line basis.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method of displaying music lyrics on a touch screen, adapted for a portable handheld electronic device, and the method comprising:
selecting an audio recording;
displaying a progress indicator of the audio recording;
receiving a first touch signal on the progress indicator;
seeking a segment of lyrics of the audio recording based on the corresponding location of the first touch signal on the progress indicator;
displaying on the touch screen a first window which emerges from the first touch signal on the progress indicator in response to the progress indicator receiving the first touch signal; and
displaying the segment of lyrics of the audio recording within the first window.

2. The method of claim 1, wherein the step of seeking the segment of lyrics of the audio recording based on the corresponding location of the first touch signal on the progress indicator comprising:
identifying the time stamp of the beginning of the segment of lyrics of the audio recording; and
changing the playing of the audio recording by playing the audio recording starting from the time stamp of the beginning of the segment of lyrics.

3. The method of claim 2, wherein before the step of identifying the time stamp of the beginning of the segment of lyrics of the audio recording, claim 2 further comprises:
dividing all lyrics of the audio recording into a plurality of segments based on a predetermined pattern and associating each segment of the lyrics with a time stamp from the audio recording;
identifying from the plurality of segments a corresponding segment from which the first touch signal is located on the progress indicator; and
identifying the corresponding segment as a beginning of a line of lyrics.

4. The method of claim 1, wherein right after the first touch signal is received, the first window disappears after a first predetermined period if no further signal is received on the progress indicator.

5. The method of claim 4 further comprising:
receiving a second touch signal on the progress indicator;
seeking lyrics of the audio recording based on the corresponding location of the second touch signal on the progress indicator;
displaying a second window on the touch screen when seeking lyrics of the audio recording; and
displaying the lyrics on the second window or displaying the lyrics and the next line of the lyrics of the audio recording within the second window.

6. The method of claim 5, wherein the second window over writes the first window, and both the first window and the second window over write a background display of the touch screen.

7. The method of claim 5, wherein the first window is deactivated when the second window is activated.

8. The method of claim 4, wherein the first window is displayed such that the first window is connected to and corresponds to the location of the first touch signal on the progress indicator.

9. The method of claim 7, further comprising:
receiving a third touch and drag signal on the progress indicator from the location of first touch signal to where the third touch and drag signal ends on the progress indicator;
displaying lyrics of the audio recording based on the corresponding location of the end of the third touch and drag signal;
moving the first window on the touch screen when displaying lyrics of the audio recording to another location corresponds to where the third touch and drag signal ends on the progress indicator.

10. The method of claim 1, wherein displaying the segment of lyrics of the audio recording within the first window comprises displaying only one line of lyrics of the audio recording or only two lines of lyrics of the audio recording within the first window.

11. A portable handheld electronic device comprising:
a storage medium configured for storing at least an audio recording;
an input unit configured for receiving a first touch signal;
a touch screen coupled to the input unit and configured for displaying a progress indicator, lyrics of the audio recording and a first window; and
a processor coupled to the storage medium, the input unit, and the touch screen and configured for:
selecting the audio recording, receiving the first touch signal on the progress indicator, seeking a segment of lyrics of the audio recording based on the corresponding location of the first touch signal on the progress indicator, displaying on the touch screen the first window which emerges from the first touch signal on the progress indicator in response to the progress indicator receiving the first touch signal, and displaying the segment of lyrics of the audio recording within the first window on the touch screen.

12. The device of claim 11, wherein the processor is configured for seeking the segment of lyrics of the audio recording based on the corresponding location of the first touch signal on the progress indicator comprising:
identifying the time stamp of the beginning of the segment of lyrics of the audio recording and changing the playing of the audio recording by playing the audio recording starting from the time stamp of the beginning of the segment of lyrics.

13. The device of claim 12, wherein before the processor is configured for identifying the time stamp of the beginning of the segment of lyrics of the audio recording, the processor is further configured for:
dividing all lyrics of the audio recording into a plurality of segments based on a predetermined pattern and associating each word of the lyrics with a time stamp from the audio recording, identifying from the plurality of segments a corresponding segment from which the first touch signal is located on the progress indicator, and identifying the corresponding segment as a beginning of a line of lyrics.

14. The device of claim 11, wherein right after the first touch signal is received by the input unit, the touch screen no longer displays the first window after a first predetermined period if the input unit does not detect any more signal on the progress indicator.

15. The device of claim 14 further comprising:
when the input unit receives a second touch signal on the progress indicator, the processor is configured for executing:
seeking the segment lyrics of the audio recording based on the corresponding location of the second touch signal on the progress indicator, displaying a second window on the touch screen when seeking lyrics of the audio recording, and displaying the line of lyrics on the second window or displaying the line of lyrics and the next line of the line of lyrics of the audio recording within the second window on the touch screen.

16. The device of claim 15, wherein the touch screen displays the second window which over writes the first window, and both the first window and the second window over write a background window of the touch screen.

17. The device of claim 15, wherein the touch screen further deactivates the first window after the second window is activated.

18. The device of claim 14, wherein the touch screen further displays the first window which is connected to and corresponds to the location of the first touch signal on the progress indicator as detected by the input unit.

19. The device of claim 7, wherein the processor is further configured for:
receiving through the input unit a third touch and drag signal on the progress indicator from the location of the first touch signal to where the third touch and drag signal ends on the progress indicator, seeking the line of lyrics of the audio recording based on the corresponding location of the end of the third touch and drag signal, and moving the first window on the touch screen when seeking the line of lyrics of the audio recording to a location corresponds to the location where the third touch and drag signal ends on the progress indicator.

20. The device of claim 1, wherein the processor is configured for displaying the line of lyrics of the audio recording within the first window comprises displaying only the line of lyrics of the audio recording or only two lines of lyrics of the audio recording within the first window.
